(19) United States
(12) Patent Application Publication
(10) Pub. No.: US 2020/0253702 A1
(43) Pub. Date: Aug. 13, 2020

(54) PORTABLE ORAL CARE APPLIANCE AND A METHOD OF UTILIZING THE SAME

(71) Applicant: Willo 32 SAS, Limoges (FR)

(72) Inventors: Jean-Marie De Gentile, Feytiat (FR); David Aurélien Barlet, Rilhac-Rancon (FR)

(73) Assignee: Willo 32 SAS, Limoges (FR)

(21) Appl. No.: 16/270,056

(22) Filed: Feb. 7, 2019

(51) Int. Cl. A61C 17/22; A46B 15/00

(52) U.S. Cl. CPC A61C 17/221; A61C 17/228; A46B 2200/1066; A61C 2204/002; A46B 15/0012

(57) ABSTRACT

An oral care appliance and a method of use are disclosed. The oral care appliance includes a mouthpiece with one or more enclosed compartments between an outer surface and an inner surface of the mouthpiece. The inner surface comprises at least one flexible membrane surrounding the one or more enclosed compartments. The oral care appliance also includes a control unit configured to regulate pressure variations in the one or more enclosed compartments to deform the flexible membrane and thereby perform an oral care action.

### BACKGROUND OF THE INVENTION

Dental cleaning plays a significant role in impacting the overall health of an individual. Many people schedule frequent visits to a dentist for regular check-up and cleaning operations. Many devices have been developed over the years to achieve the purpose of oral hygiene. These devices are either electrical or non-electrical. Among the above-mentioned categories of dental cleaning devices, electric dental units have gained popularity. Some examples of electric dental units are electric toothbrushes, water picks and electric flosses which intend to provide cleaning results by eradicating the food remains, plaque, etc. from the spaces in between the teeth. These devices tend to require less user intervention in their operation and some are also suitable for people with reduced mobility or people on the move for whom it is difficult to use a traditional toothbrush. However, it is necessary to provide and improve existing dental units for ensuring satisfactory cleaning results.

These conventional dental cleaning appliances require frequent user intervention like manually guiding of the device for performing oral cleaning. Since these appliances are difficult to guide between interdental gaps and inner surfaces of the teeth, cleaning quality is non-uniform and poor. Further, a high degree of user compliance with techniques and/or instructions of the appliance need to be followed, which many users, particularly children and elderly, may find difficult to follow. For example, user may under-do or overdo the brushing either by not following the recommended brushing process or time spent per tooth, or by vigorously applying non-uniform pressure while brushing. Further, these appliances are comparatively less adaptable for people with disabilities or reduced mobility.

### SUMMARY OF THE INVENTION

Specific embodiments of the present invention disclosed herein relate to an oral care appliance and a method of utilizing oral care appliance for providing oral care hygiene. The oral care appliance can be used for cleaning, whitening, removing plaque, and in other general oral care applications. The oral care appliance can be portable. The oral care appliances are able to address one or more of the disadvantages of conventional devices mentioned above and improve the dental health of a user by improving the effectiveness and user satisfaction of such oral care appliances and systems.

In specific embodiments of the invention, a portable oral care appliance is provided. The portable oral care appliance comprises a mouthpiece configured to form a cavity with a dental arch and having an outer surface and an inner surface. The inner surface comprises at least one flexible membrane. The appliance also comprises one or more enclosed compartments formed between the outer surface and the inner surface of the mouthpiece. The appliance also comprises a handle attached to the mouthpiece and having a control unit. The control unit is configured to regulate pressure variations in the one or more enclosed compartments to deform the flexible membrane for performing an oral care action.

In specific embodiments of the invention, the oral care action may comprise one or more oral care cleaning cycles managed by the control unit. Each of the one or more oral care cleaning cycles may comprise at least one contraction phase and at least one relaxation phase of the mouthpiece.

In specific embodiments of the invention, the oral care action may be performed by a plurality of cleaning elements attached to the at least one flexible membrane.

In specific embodiments of the invention, the control unit may be configured to deform the at least one flexible membrane of the mouthpiece to transfer movement to the plurality of cleaning elements in a controlled manner to thereby perform the oral care action.

In specific embodiments of the invention, the plurality of cleaning elements may be bristles made up of an elastomeric material.

In specific embodiments of the invention, the plurality of cleaning elements may be bristles made up of polyamide.

In specific embodiments of the invention, the control unit may be configured to regulate pressure inside the one or more enclosed compartments to create the contraction phase and the relaxation phase of the mouthpiece.

In specific embodiments of the invention, the control unit may comprise one or more of a pump, a motor, a valve mechanism, and/or a depression chamber.

In specific embodiments of the invention, the control unit may comprise a sensing means to monitor at least one operational characteristic.

In specific embodiments of the invention, the operational characteristic may be selected from a plurality of operational characteristics comprising pressure, volume, flow rate, time, and user input.

In specific embodiments of the invention, the control unit may comprise a power supply means, a battery, or a combination thereof.

In specific embodiments of the invention, a cleaning agent may be injected inside the user's mouth for performing the oral care action.

In specific embodiments of the invention, at least a portion of the outer surface of the mouthpiece may be made up of a rigid material.

In specific embodiments of the invention, at least a portion of the outer surface of the mouthpiece may be made up of a flexible material.

In specific embodiments of the invention, the mouthpiece may comprise at least one of an inlet hole, an outlet hole, or a combination thereof.

In specific embodiments of the invention, the mouthpiece may comprise a U-shaped upper portion and a U-shaped lower portion connected to each other. The upper portion and the lower portion are configured to perform oral care action on an upper dental arch and a lower dental arch simultaneously or separately.

In specific embodiments of the invention, a method for utilizing a portable oral care appliance for providing oral care hygiene is provided. The method comprises varying pressure in one or more enclosed compartments of a mouthpiece by a control unit. The one or more enclosed compartments are formed between an inner surface and an outer surface of the mouthpiece. The method also comprises deforming at least one flexible membrane of the inner surface in response to the pressure variations caused in the one or more enclosed compartments. The at least one flexible membrane is arranged to surround the one or more enclosed compartments. The method also comprises performing an oral care action by operating a plurality of cleaning elements attached to the at least one flexible membrane in response to the deformation caused in the at least one flexible membrane by the pressure variations.

In specific embodiments of the invention, the oral care action may comprise one or more oral care cleaning cycles.

In specific embodiments of the invention, the method may comprise a step of injecting a cleaning agent during the oral care action.

One or more of the embodiments/steps of the invention can also be automated, completely or partially, using one or more components such as a control system, timer, sensing means, and software.

Various objects, features, aspects and advantages of the present disclosure will become more apparent from the following detailed description of preferred embodiments, along with the accompanying drawing figures in which like numerals represent like features.

### BRIEF DESCRIPTION OF DRAWINGS

FIG. 1 illustrates a portable oral care appliance 10 in accordance with specific embodiments of the invention disclosed herein.

FIG. 2 illustrates a cross-sectional view of a mouthpiece 100 in accordance with specific embodiments of the invention disclosed herein.

FIG. 3 illustrates a mouthpiece 120 in accordance with specific embodiments of the invention disclosed herein.

FIGS. 4A and 4B illustrate an enclosed compartment 108 formed in a mouthpiece 100 in accordance with specific embodiments of the invention disclosed herein.

FIGS. 5A and 5B illustrate a mouthpiece 100 having a plurality of enclosed compartments 108A, 108B and 108C in accordance with specific embodiments of the invention disclosed herein.

FIG. 6 illustrates a perspective view of a mouthpiece 100 in accordance with specific embodiments of the invention disclosed herein.

FIG. 7 illustrates various components of a control unit 300 in accordance with specific embodiments of the invention disclosed herein.

FIG. 8 illustrates a flow diagram of a method 800 of utilizing the portable oral care appliance 10 in accordance with specific embodiments of the invention disclosed herein.

FIG. 9 illustrates a portable oral care appliance 10 comprising a cleaning agent injection unit 316 in accordance with specific embodiments of the invention disclosed herein.

### DETAILED DESCRIPTION OF THE INVENTION

Aspects of the present invention can be understood by reference to the figures and description set forth herein. However, the following descriptions, and numerous specific details thereof, are given by way of illustration and not of limitation. Many changes and modifications to the specific descriptions may be made without departing from the spirit and scope thereof, and the present invention includes all such modifications. It is to be understood that the embodiments may or may not overlap with each other. Thus, part of one embodiment, or specific embodiments thereof, may or may not fall within the ambit of another, or specific embodiments thereof, and vice versa.

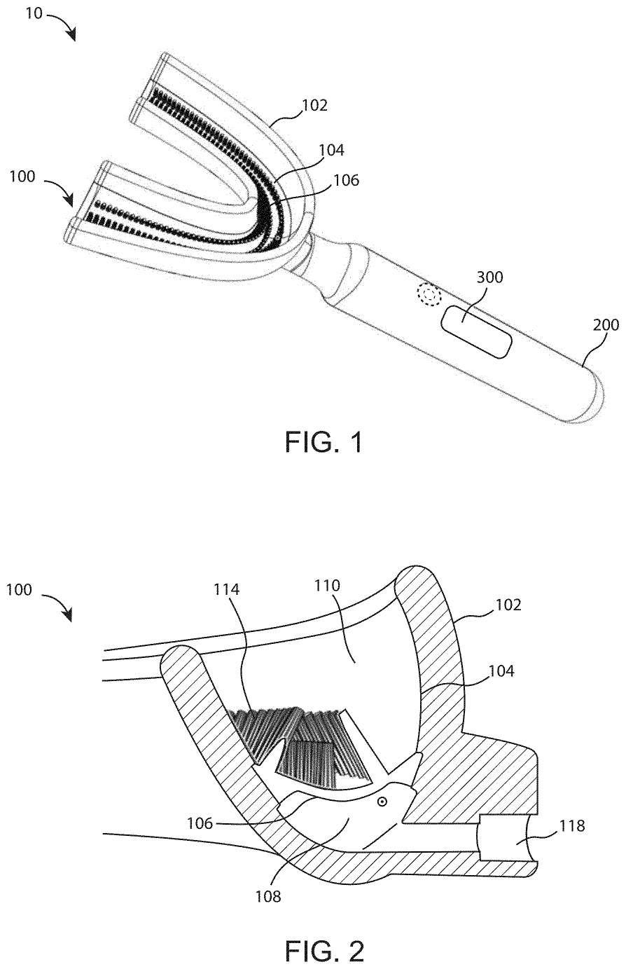

FIG. 1 illustrates a portable oral care appliance 10. The portable oral care appliance 10 comprises a mouthpiece 100 configured to form a cavity with a user's dental arch. The mouthpiece 100 comprises one or more enclosed compartments formed between an outer surface 102 of the mouthpiece 100 and an inner surface 104 of the mouthpiece 100. The inner surface 104 of the mouthpiece 100 further comprises at least one flexible membrane 106 surrounding, at least partially, the one or more enclosed compartments.

The portable oral care appliance 10 further comprises a handle 200 attached to the mouthpiece 100, wherein the handle 200 comprises a control unit 300 configured to regulate pressure variations in the one or more enclosed compartments to deform the flexible membrane 106, and thereby perform an oral care action in the user's mouth.

The portable oral care appliance 10 is configured to provide optimum oral care action in the user's dental arch by varying the pressure in the one or more enclosed compartments of the mouthpiece 100. The portable oral care appliance 10 can be utilized for oral cleaning, removing plaque, whitening and in other general oral care applications.

FIG. 2 illustrates a cross-sectional view of a mouthpiece 100 according to an embodiment of the invention. The mouthpiece 100 comprises the inner surface 104 and the outer surface 102, wherein the outer surface 102 and the inner surface 104 can be made up of similar or different materials suitable for oral care use. According to another embodiment, at least a portion of the outer surface 102 and the inner surface 104 of the mouthpiece 100 are made up of a rigid material. The rigid material can be selected from plastic, PVC (polyvinyl chloride), a high-density polyethylene polymer, Nylon or other such similar materials.

In specific embodiments of the invention, at least a portion of the outer surface 102 and the inner surface 104 of the mouthpiece 100 can be made up of a flexible material. Examples of flexible materials can be, but are not limited to, rubber, plastic, silicone, latex, polymer, and other soft and flexible material suitable for oral care applications.

Thermoplastic elastomer (TPE) are suitable as flexible materials for oral care applications. They are copolymers consisting in a physical mix of polymers having plastic and elastomeric properties. Furthermore, they have a suitable temperature range of operation, between −10° C. and 80° C. They can have good food and medical grade properties as well as an absence of significant creep. Furthermore, they have good tearing and tensile strength. This makes TPEs suitable for constituting the flexible material of the mouthpiece 100.

Silicone is another polymer suitable as flexible material for oral care applications. It is a very stable polymer with low chemical reactivity. Furthermore it is stable over a large range of temperature (between −100° C. and 250° C.). It also has excellent creep, tear strength and elongation properties. In addition, it also has good food and medical grade properties making suitable for the flexible material of the mouthpiece 100.

For pleasing of the eyes, the inner and outer surface of the mouthpiece can be coloured or transparent with visual effect or not, textured or not.

The mouthpiece 100 may form a cavity 110 between the mouthpiece 100 and the dental arch of the user when the mouthpiece 100 is placed on the dental arch. The cavity 110 can be a closed or nearly closed space between the mouthpiece 100 and the dental arch of the user.

In specific embodiments of the invention, the outer surface 102 of the mouthpiece 100 is partially, or totally, rigid to help deformation of the flexible membrane 106 towards specific regions of the dental arch during the oral care action. The flexible membrane 106 is configured to surround, at least partially, one or more enclosed compartments 108 formed between the inner surface 104 and the outer surface 102 of the mouthpiece 100.

Accordingly, the pressure variations in the one or more enclosed compartments 108 result in volume changes of the enclosed compartment 108, thereby deforming the flexible membrane 106. For instance, a positive pressure, relatively to ambient pressure, inside the enclosed compartment 108 increases its volume and a negative pressure, relatively to ambient pressure, inside the enclosed compartment 108 decreases its volume.

In some embodiments, the volume of the one or more enclosed compartments 108 is between 1 and 10 cubic centimeters. Preferentially, the volume of the one or more compartments 108 is between 2 and 5 cubic centimeters.

In some embodiments, the pressure variation inside the one or more enclosed compartments is varied over a range of pressure between 200 kPa and 1 kPa. More specifically, the range of variation of pressure inside the one or more compartments 108 is varied over a range of 40 kPa.

As explained above, the flexible membrane 106 is deformed by the control unit 300 by varying the pressure in the one or more enclosed compartments 108. In specific embodiments of the invention, a plurality of cleaning elements 114 are arranged on the flexible membrane 106 as shown in FIG. 2, therefore the deformation of the flexible membrane 106 by the control unit 300 causes movements in the plurality of cleaning elements 114 in a controlled manner that helps in performing the oral care action in the user's mouth. Oral care appliances in accordance with this disclosure can use any form of cleaning element and are not limited to the use of bristles such as those used to illustrate the cleaning elements 114 in FIG. 2. The cleaning elements 114 may include a set of cylindrical or conical bristles which may be glued, over-molded or attached to the flexible membrane 106 by other means. In specific examples, the shape of the cleaning elements 114 can be conical, cylindrical, flat, pointed tip, tapered, star-shaped, zig-zag, strips, forks, or any combination thereof. The plurality of cleaning elements 114 can be disposed in different angular arrangements on the flexible membrane 106 of the mouthpiece 100 to provide effective cleaning around and in between the dental arch of the user.

In some embodiment, the oral car action of the cleaning elements 114 can consist of a mechanical action such as rubbing, sliding, deforming, rotating, vibrating or any other particular movement on the surface of the teeth of the user.

In specific embodiments of the invention, the plurality of cleaning elements 114 are bristles made up of an elastomeric material such as foam, rubber etc. The elasticity of cleaning elements 114 enhances the cleaning between the interdental spaces in the dental arch of the user without harming the gums or teeth of the user, especially with patients having specific dental issues. This pressure sensor can be an absolute or differential pressure gauge, a diaphragm gauge, a force balance sensor, a strain gauge or any other mean designed to measure the pressure of the fluid entering the mouthpiece 100 known to a person skilled in the art.

In specific embodiments of the invention, the plurality of cleaning elements 114 are bristles made up of polyamide. Polyamide is a well-known and used material in the oral care industry. Polyamides are a family of polymers made of repeating units linked by amide links. They have good temperature stability and high elongation and abrasion resistance. Furthermore, polyamide is easily processed into fibers and have a high wettability. Dental plaque consisting in water for a large part, polyamides are then suitable for the rigid material of the cleaning elements.

In specific embodiments of the invention, the one or more enclosed compartments 108 can be formed at any region between the inner surface 104 and the outer surface 102 of the mouthpiece 100. The one or more enclosed compartments 108 can be any shape including, but not limited to, circular, rectangular, triangular, and polygonal, to provide adequate hermeticity and deformation of the flexible membrane 106 of the mouthpiece 100. In specific examples, the multiple enclosed compartments 108 in the mouthpiece 100 can be separated using walls made of soft material, rigid material, or a combination thereof.

The mouthpiece 100 can also be made up of flexible material impermeable to gases (such as air), liquids (water, cleaning liquid, disinfecting liquid) and any solid (waste particles, debris) such as, but not limited to, latex or silicone compatible with medical or oral care use. The mouthpiece 100 can be beneficially designed to be impermeable to gases, liquids and any solids so as to guarantee that no leak is present when the difference of pressure is generated between the compartment 108 and ambient atmosphere.

In specific embodiments of the invention, the mouthpiece 100 can be in a form of a U-shaped mouthpiece. The mouthpiece 100 can be molded/pre-shaped in a curved shape forming an arch, U-shape, c-shape, horseshoe shape, or any other shape allowing easy insertion of the mouthpiece 100 around the dental arch of the user.

In specific embodiments of the invention, the shape of the mouthpiece 100 can be adapted for adjustment to match the height of gingiva and teeth of the user. The adaptability of the mouthpiece 100 according to different shapes and heights of the users gingiva and teeth yields in providing satisfactory dental cleaning to different users with different configurations of the dental arch.

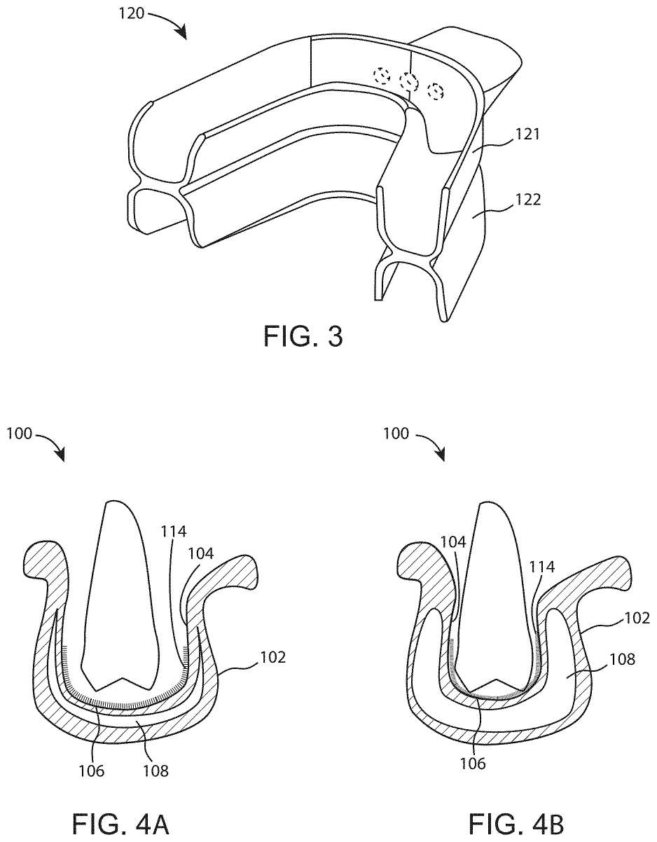

In specific embodiments of the invention as shown in FIG. 3, a mouthpiece 120 is illustrated to provide the oral care action on an upper dental arch and lower dental arch of the user simultaneously or separately. The mouthpiece 120 comprises an upper portion 121 and a lower portion 122 connected to each other. The mouthpiece 120 according to this embodiment reduces time for brushing the teeth. The mouthpiece 120 may further include one or more enclosed compartments in each of the upper portion 121 and the lower portion 122.

In specific embodiments of the invention, the pressure can be varied in the one or more enclosed compartments of the upper portion 121 and the lower portion 122 of the mouthpiece 120 by the control unit 300 at the same time to perform the oral care action simultaneously in both dental arches of the user. In yet another embodiment, the pressure can be varied in the one or more enclosed compartments of the upper portion 121 and the lower portion 122 by the control unit 300 at different times.

It is to be understood by the person of ordinary skilled in the art that the embodiments described in reference to the mouthpiece 100 can be implemented for the mouthpiece 120.

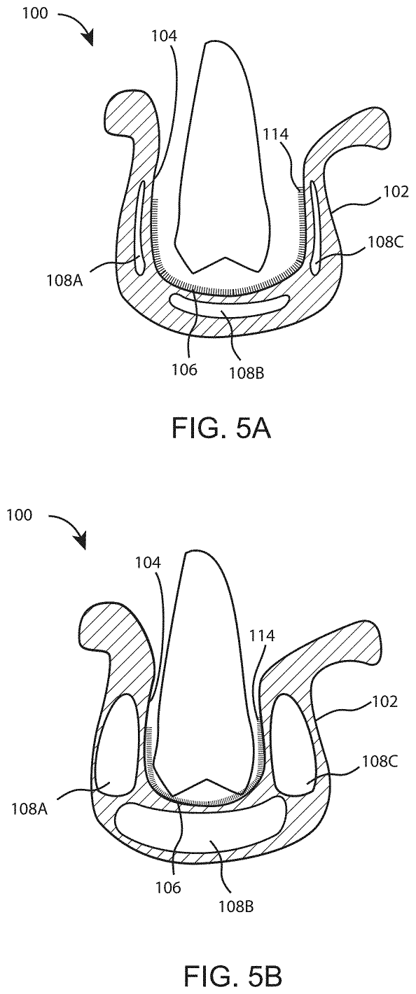

In specific embodiments of the invention, FIG. 4A, FIG. 4B, FIG. 5A, and FIG. 5B show different configurations of the one or more enclosed compartments 108 formed within the mouthpiece 100.

FIG. 4A illustrates a mouthpiece 100 having one enclosed compartment 108 formed between the outer surface 102 and the inner surface 104, wherein the inner surface 104 comprises at least one flexible membrane 106. Further, the flexible membrane 106 is arranged to surround, at least partially, the enclosed compartment 108, and the plurality of cleaning elements 114 are arranged on the flexible membrane 106. The control unit 300 is configured to vary pressure in the enclosed compartment 108.

FIG. 4B illustrates the enclosed compartment 108 with increased volume due to pressure variations regulated by the control unit 300, leading to deformation of the flexible membrane 106 towards the dental arch of the user, herein referred to as the contraction phase of the mouthpiece 100. Further, the deformation of the flexible membrane 106 causes movement of cleaning elements 114 towards the dental arch of the user to perform the oral care action in the user's mouth.

The mouthpiece 100 can return to the state illustrated by FIG. 4A from the state illustrated by FIG. 4B. The decrease in the pressure inside the enclosed compartment 108 leads to decrease of the volume of the compartment 108 and hence, the cleaning elements 114 move away from the dental arch, herein referred to as the relaxation phase of the mouthpiece 100. Therefore, the changes in the volume of the enclosed compartment 108 in response to the pressure variations regulated by the control unit 300 allow the oral care action to be performed on the user's dental arch.

FIG. 5A illustrates a mouthpiece 100 having a plurality of enclosed compartments 108A, 108B and 108C formed between the outer surface 102 and the inner surface 104 of the mouthpiece 100 according to an embodiment of the invention. The plurality of enclosed compartments 108A, 108B and 108C facilitate in distributing pressure variations across the dental arch of the user as per the requirements, which thereby improves the efficiency of the oral care action.

In specific embodiments of the invention, pressure variations in the enclosed compartments 108A, 108B and 108C can be distributed unequally as per certain requirements. For example, in some specific dental issues, the right side of the user's dental arch may require oral care action with more pressure, therefore more pressure variations can be applied to the enclosed compartment 108C in comparison to the other two enclosed compartments 108A and 108B.

Therefore, the mouthpiece 100 of the portable oral care appliance 10 can be suitably designed to include multiple enclosed compartments 108A, 108B and 108C arranged in such a manner that the optimal oral care action can be achieved by applying different pressure variations at different regions of the user's dental arch.

In specific embodiments of the invention, each of the plurality of enclosed compartments 108A, 108B and 108C can be provided with dedicated inlet/outlet ports/holes so that pressure variations can be distributed as per the aforementioned requirements.

The arrangement and configuration of the one or more enclosed compartments 108 can be customized for a specific user based on one or more focus areas corresponding to an identified dental problem of the corresponding specific user. Examples of such customizations include, but not limited to, variations in one or more of the position, width, height, number, shape, material and spacing between the plurality of enclosed compartments 108.

FIG. 5B illustrates the contraction phase of the mouthpiece 100 having multiple enclosed compartments 108A, 108B and 108C under the influence of the pressure regulated by the control unit 300. As shown, when the pressure in the enclosed compartments 108A, 108B and 108C increases, the volume of the compartments 108A, 108B and 108C also increases. Therefore, the flexible membrane 106 is deformed towards the dental arch in response to the increased volume of the enclosed compartments 108A, 108B and 108C.

It should be appreciated, by those skilled in the art, that the one or more enclosed compartments 108 as illustrated in FIG. 4A and FIG. 5A are disclosed with respect to the mouthpiece 100, and the similar configuration of one or more enclosed compartments 108 can also be replicated for a mouthpiece 120.

In an alternate embodiment of the invention, the inner surface 104 of the mouthpiece 100 is designed to act as a flexible membrane 106. In yet another embodiment of the present invention, the part of the inner surface 104 contacting the dental arch of the user can be made up of soft material (e.g., foam) to provide adequate comfort to a user during oral care applications.

In specific embodiments of the invention, the mouthpiece 100 can be formed of an inflatable material. The mouthpiece 100 can be inflated/deflated in response to the pressure variations in the one or more enclosed compartments 108 of the mouthpiece 100 to perform an effective oral care action in a user's teeth arches.

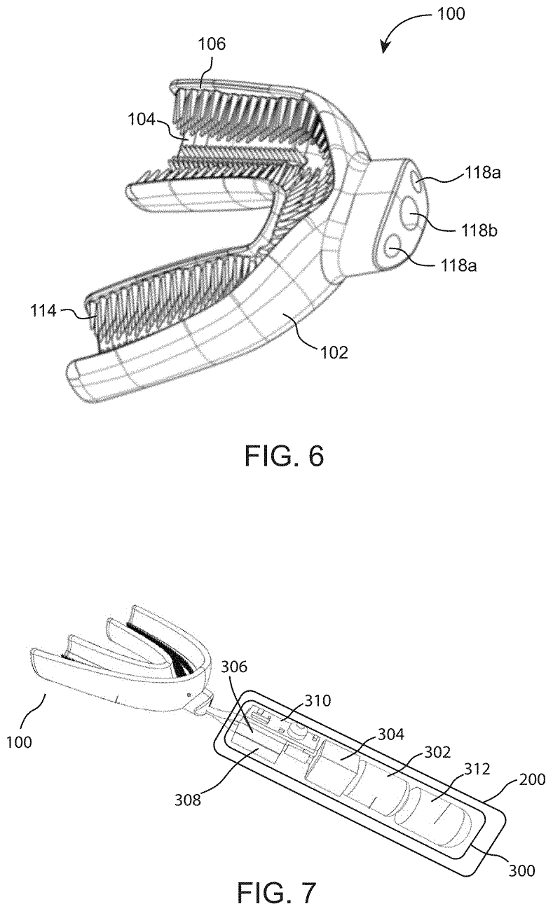

In specific embodiments of the invention as shown in FIG. 6, the mouthpiece 100 further comprises a plurality of holes 118a, 118b for injecting/draining of a fluid/cleaning agent/oral care solution into/from the mouthpiece 100. In particular examples, the at least one hole 118a can be used for injecting the fluid inside the mouthpiece 100 and the at least one hole 118b for draining the fluid out of the mouthpiece 100. In further examples, the plurality of holes 118 can be placed on any other position of the mouthpiece 100. In a different example, a single hole can be used for injecting/draining the fluid/cleaning agent/oral care solution. In another example of the invention, the injection hole 118a is placed in close proximity to the draining hole 118b. During operation of the oral care cycle, injection of liquid through the at least one hole 118a can be in excess and thus can prove uncomfortable for the user. The short distance between the at least one hole 118a and the draining hole 118b allow the excess of such a liquid to be immediately drained out of the of the mouthpiece.

In specific embodiments of the invention, the oral care action comprises one or more oral care cleaning cycles controlled by the control unit 300. Each of the oral care cleaning cycles comprises at least one contraction phase and at least one relaxation phase of the mouthpiece 100.

In specific embodiments of the invention, each of the contraction phase and the relaxation phase of the mouthpiece 100 are achieved due to pressure variations caused in the enclosed compartments 108. During the contraction phase, a positive pressure relative to ambient pressure in the compartment 108 increase its volume while during the relaxation phase, a decrease in pressure in the compartment 108 decreases the volume of the compartment 108.

In specific embodiments of the invention, each oral care cleaning cycle comprises a sequence of at least one contraction phase and at least one relaxation phase, wherein the sequence can be repeated one or more times as per the user's profile and requirements. It is to be understood to the person skilled in the art that any sequence of the contraction phase and the relaxation phase is possible depending upon the requirements. The one or more contraction/relaxation phases can be comprised in a sequence.

In specific embodiments of the invention, the handle 200 is attached to the mouthpiece 100. The mouthpiece 100 can be attached to the handle in a fixed-type arrangement or can be easily detachable from the handle 200 for easy replacement of either component. In another exemplary embodiment of the invention, multiple mouthpieces can be attached to the handle 200.

The handle 200 comprises the control unit 300 to regulate the pressure in the enclosed compartments 108. As shown on FIG. 7, the control unit 300 can include a plurality of electrical, electronic and mechanical components.

Specifically, the control unit 300 can include one or more of a pump 302, a motor 304, a first valve 306, a second valve 308, an actuator and/or a depression chamber. The first valve 306 and the second valve 308 form a valve mechanism. These components act as means for varying pressure inside the one or more enclosed compartments 108 of the mouthpiece 100. Different combinations of various means for varying pressure can be used depending on the requirements. For example, only pump 302 can be used for varying pressure or, alternatively, the pump 302 with the valve mechanism can be used. In specific embodiments of the invention, the pressure inside the one or more enclosed compartments 108 can be varied using a depression chamber. For example, the depression chamber can be placed between pump 302/motor 304 and the valve mechanism. In another example, the depression chamber can be placed outside the portable oral care appliance 10 (e.g. as a separate unit). The depression chamber can be used to increase the speed of pressure variations inside the one or more enclosed compartments 108 to facilitate optimal oral care action in the user's dental arch.

In specific embodiments of the invention, the control unit 300 also comprises a power supply means 312 including, but not limited to, a power adapter, a battery, alternative energy sources like solar cells and piezoelectric energy harvesters or a combination thereof. The battery can be a rechargeable battery and/or a replaceable battery. The inclusion of the battery in the portable oral care appliance 10 allows it to function cordlessly, and thus the portable oral care appliance 10 can be used as a handheld unit. The portable oral care appliance 10 can also include a power button to switch on or off the portable oral care appliance 10.

In specific embodiments of the invention, the pump 302 can be a vacuum pump, peristaltic pump, a tailor-made pump, a one-way pump, a hermetic pump or a two-way pump. The pump 302 transforms electrical energy in mechanical work used to move fluid from or into the one or more enclosed compartments 108 of the mouthpiece 100. This fluid movement increases or decreases the pressure inside the one or more enclosed compartments 108.

In addition, the control unit 300 also comprises a sensing means 310 to monitor at least one operational characteristic. The sensing means 310 can be a pressure sensor, volume sensor, flow sensor, a timer, or other sensor known to a person skilled in the art. In specific embodiments, a volume sensor is configured to measure the volume of fluid entering the mouthpiece 100. In specific embodiments, a pressure sensor is configured to measure the pressure inside the compartment 108 or between some components of the oral care appliance 10. This pressure sensor can be an absolute or differential pressure gauge, a diaphragm gauge, a force balance sensor, a strain gauge or any other mean designed to measure the pressure of the fluid entering the mouthpiece 100 known to a person skilled in the art. In a specific example, the pressure sensor can measure the pressure by using a piezo-resistive component. A piezo-resistive component's electrical resistivity changes when mechanical strain is applied onto the component. This change can then be measured. In this specific embodiment, the changes in pressure applies strain on the piezo-resistive component. In specific embodiments, a flow sensor is configured to measure the flow rate of fluid into the mouthpiece 100. This flow sensor can be a Pitot tube, a differential pressure-based flow meter, a volumetric based flow meter, a turbine based flow meter, a velocity measurement-based flow meter or any other mean designed to measure the flowrate of the fluid entering the mouthpiece 100 known to a person skilled in the art. In a particular embodiment, the flow sensor measures the flow rate in or out of the one or more compartments 108. In a specific embodiment, the flowrate sensor measures the air flowrate in or out of the one or more compartments 108 by measuring the temperature before and after a heating element placed in the path of the flow. Heat transfer takes place at a given rate as a function of the gas flowrate and thus, by measuring the temperature after and before the heater, the flowrate can be measured. In specific embodiments, a timer is configured to measure time of functioning of any components of the control unit 300.

Thus, the sensing means 310 may monitor operational characteristics, (e.g. pressure, volume, flow rate, time and user input), to control the operation of the oral care appliance 10 or the oral care cleaning cycle. Moreover, the operational characteristics may further relate to pressure inside the compartment 108, pressure difference between the components of the oral care appliance 10, pressure measured during the contraction/relaxation phase of the mouthpiece 100, volume of fluid inside the compartment 108, flow rate of the fluid coming in and out of the mouthpiece 100, pre-set time fixed for working of other means or components of the oral care appliance 10, or combinations of one or more of those which allow the oral care appliance 10 to work efficiently. As explained above, negative and positive pressure, relatively to ambient pressure, inside the compartment 108 creates the contraction phase and the relaxation phase of the mouthpiece 100. However, increases and decreases in volume of the fluid inside the cavity, inflow rate and outflow rate and other operational characteristics may also contribute to the contraction phase and the relaxation phase of the mouthpiece 100. In one example, the operational characteristics can also be defined by the user (i.e., the user can set the operational characteristics to control the oral care action). Based on these user inputs, the control unit 300 regulates the at least one of the contraction phase and/or the relaxation phase of the mouthpiece 100.

In specific embodiments of the invention, the control unit 300 comprises a microprocessor or the like. The microprocessor 310 uses the inputs provided by the sensing means 310 and sends a command signal to the means for varying pressure when the operational characteristic reaches a targeted threshold value. Accordingly, the means for varying pressure cause an increase/decrease of the pressure in the compartments 108 depending on the command signal transmitted by the microprocessor. In other terms, the microprocessor triggers the means for varying pressure when at least one operational characteristic reaches a targeted threshold value, thereby allowing the contraction phase and the relaxation phase of the mouthpiece 100 to be controlled.

In specific embodiments of the invention, the pump 302 and/or the motor 304 is used for injecting/extracting fluid (e.g., air and/or liquid) in the one or more enclosed compartments 108. The pump 302 and the motor 304 can be used separately or in combination in the oral care applications depending on the functionality of the portable oral care appliance 10 and/or the oral care requirements. The pressure in the one or more enclosed compartments 108 can be regulated by using the first valve 306 and/or the second valve 308.

For instance, the first valve 306 is opened to inject the fluid (e.g., air and/or liquid) in the one or more enclosed compartments 108 when the pressure between the pump 302/motor 304 and the valve mechanism reaches a calibrated value, which is measured by the sensing means 310. The volume of the one or more enclosed compartments 108 increases accordingly, which thereby deforms the flexible membrane 106 and thus facilitates the contraction of the mouthpiece 100 on the dental arch of a user. The first valve 306 is then closed once the pressure inside the compartment 108 reaches the targeted threshold value. In a specific embodiment, the calibrated value can be set by the user as per the oral care requirements. In another embodiment, the calibrated value can be set automatically by the control unit 300 depending on the oral care requirements.

The contraction phase is followed by the relaxation phase, wherein the second valve 308 is opened once pressure in the one or more enclosed compartments 108 reaches the targeted threshold value. The opening of the second valve 308 balances the pressure between the one or more enclosed compartments 108 and the outer surface 102, which brings the one or more enclosed compartments 108 to their original shape, thereby relaxing the mouthpiece 100.

In specific embodiments of the invention, the first valve 306 and the second valve 308 can be electrically or mechanically operated valves. According to different examples, the first valve 306 and the second valve 308 can be, but are not limited to, a solenoid valve, a servo-valve, a pneumatic control valve, any electronic valve with pinch valve, or a membrane valve.

In specific embodiments of the invention, the mouthpiece 100 can be provided with pressure regulators such as, but not limited to, a pressure limiter, and a pressure relief valve. The pressure regulator is configured to function in coordination with the control unit 300 to regulate the pressure inside the one or more enclosed compartments 108 of the mouthpiece 100. The pressure regulators can be located anywhere in the mouthpiece 100.

In specific embodiments of the invention, the control unit 300 is configured to adjust the one or more oral care cleaning cycles according to a user's oral care requirements. For example, the adjustment of the oral care cleaning cycle may include setting one or more functional parameters in relation to, for instance, duration between the contraction phase and the relaxation phase, number of contraction/relaxation phases, contraction/relaxation pressure threshold, and/or any other functional parameter in relation to operational characteristics of the oral care cleaning cycle.

In specific embodiments of the invention, the control unit 300 can also be configured to adjust one or more parameters including, but not limited to, operating pattern of the plurality of cleaning elements 114, duration of the oral care cleaning cycle, number of oral care cleaning cycles, frequency of oral care cleaning cycle, and operating angle of the plurality of cleaning elements 114. In another embodiment, one or more of the aforementioned parameters can be defined by the user to achieve a desired oral care action such as but not limited to curing a periodontitis, curing sensitive gums, whitening, bleaching or ensuring the appropriate treatment after a surgery. In specific embodiments of the invention, one or more of the aforementioned parameters can be automatically adjusted by the control unit 300 depending on the user's oral care requirements.

In specific embodiments of the invention, the pressure inside the one or more enclosed compartments 108 can be controlled using manual techniques such as by a user's movement to inflate/deflate the one or more enclosed compartments 108. For example, the user can be provided with a hand pump or a pumping ball which can be used manually by the user to inflate or deflate the one or more enclosed compartments 108, thereby creating pressure variations to perform the oral care action.

In specific embodiments of the invention, a method for utilizing the portable oral care appliance 10 for providing oral care hygiene is provided. The method comprises the steps of: varying pressure in the one or more enclosed compartments 108 of the mouthpiece 100 by the control unit 300. The one or more enclosed compartments are formed between the inner surface 104 and the outer surface 102 of the mouthpiece 100. The method also comprises deforming the at least one flexible membrane 106 of the inner surface 104 in response to the pressure variations caused in the one or more enclosed compartments 108. The at least one flexible membrane 106 is arranged to surround the one or more enclosed compartments 108. The method also comprises performing the oral care action in the user's mouth by operating the plurality of the cleaning elements 114 attached to the at least one flexible membrane 106 in response to the deformation caused in the at least one flexible membrane 106 by the pressure variations.

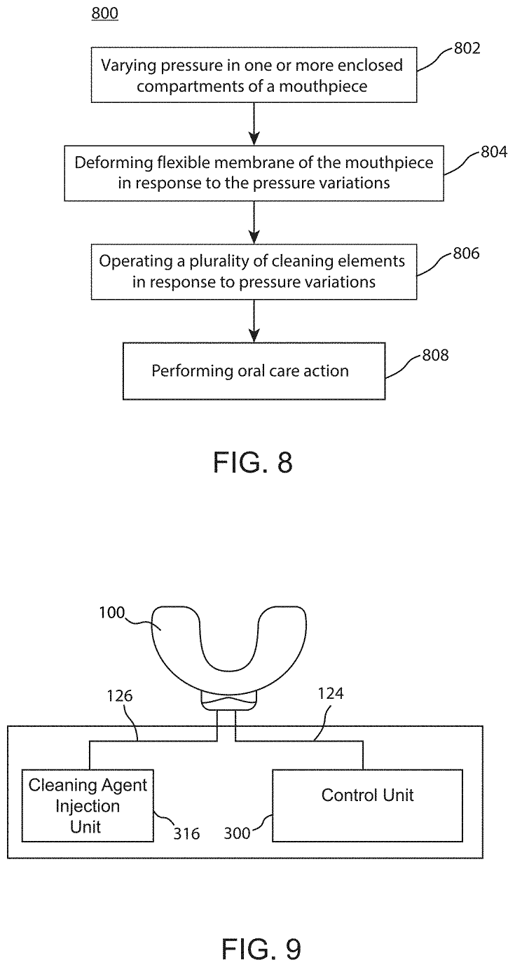

FIG. 8 schematically shows a flow diagram of a method 800 of utilizing the portable oral care appliance 10 for providing oral care hygiene according to a specific embodiment of the invention. The method starts at step 802, where pressure is varied in one or more enclosed compartments 108 of a mouthpiece 100 by the control unit 300. Then, a step 804 consists of deforming the flexible membrane 106 of the mouthpiece 100 in response to pressure variations. At step 806, a portion of or substantially all of a plurality of cleaning elements 114 attached to the flexible membrane 106 are operated in a controlled manner due to the deformation of the flexible membrane 106. At step 808, the oral care action is performed on the dental arch of the user due to the controlled movement of the some of or substantially all of the plurality of cleaning elements 114.

In yet another embodiment of the invention, a cleaning agent can also be injected in the mouthpiece 100 during the oral care action. The cleaning agent can be used to provide effective cleaning of the user's dental arch during the movement of some of or substantially all of the plurality of cleaning elements 114. The cleaning agent can be delivered by a cleaning agent injection unit 316 (shown in FIG. 9). The cleaning agent can be liquid, solid, powder, emulsion, gels, fluid, or a combination thereof.

The cleaning agent referred to herein could be: a polishing agent such as an inert abrasive; a cleaning agent such as fluoride, activated charcoal, or a fluoride-fee antibacterial composition; a halitosis treatment agent such as chlorine dioxide; or a whitening agent such as hydrogen peroxide. The cleaning agent could also be any mixture of these kinds of agents and chemicals.

FIG. 9 illustrates components of a portable oral care appliance 10 in specific embodiments of the invention. As shown in FIG. 9, the portable oral care appliance 10 is arranged to include a cleaning agent injection unit 316. According to these embodiments, a cleaning agent is injected in the mouthpiece 100 to provide efficient cleaning in the user's dental arch during the movement of some of or substantially all of the plurality of cleaning elements 114, wherein the cleaning agent is injected in the mouthpiece 100 by the cleaning agent injection unit 316. In some specific examples, the cleaning agent injection unit 316 can be configured to receive the cleaning agent from a supply tank. Accordingly, in this embodiment, the control unit 300 is connected to the mouthpiece 100 through a first connection 124 and the cleaning agent injection unit 316 is connected to the mouthpiece 100 through a second connection line 126.

According to another alternate embodiment of the invention, the cleaning agent injection unit 316 can be a part of the control unit 300.

The injection of the cleaning agent and the contraction/relaxation of the mouthpiece 100 can be coordinated to enhance the efficiency of the oral care action. For example, the cleaning agent can be injected inside the mouthpiece 100 when some of or substantially all of the plurality of cleaning elements 114 start operating due to the deformation of the flexible membrane 106 in response to the pressure variations in the one or more enclosed compartments 108. In some specific examples, the cleaning agent can be injected inside the mouthpiece 100 after a certain time has elapsed since some or substantially all the plurality of cleaning elements 114 started operating.

In specific embodiments of the invention, the injection of the cleaning agent by the cleaning agent injection unit 316 can be repeated several times during the oral care cleaning cycle to achieve the desired oral care action.

Although the invention has been described with regard to its embodiments, specific embodiments and various examples, it should be understood that various changes and modifications as would be obvious to one having the ordinary skill in this art may be made without departing from the scope of the invention as set forth in the claims appended hereto.

1. A portable oral care appliance comprising:
a mouthpiece, configured to form a cavity with a dental arch, having an outer surface and an inner surface, wherein the inner surface comprises at least one flexible membrane;
one or more enclosed compartments formed between the outer surface and the inner surface of the mouthpiece;
a handle, attached to the mouthpiece, having a control unit;
a pressure sensor to measure pressure variations in the one or more enclosed compartments; and
wherein the control unit is configured to regulate pressure variations in the one or more enclosed compartments, using the pressure sensor, to perform an oral care action with the flexible membrane by: contracting the flexible membrane directly onto the dental arch by deforming the flexible membrane towards the surface of the dental arch; and relaxing the flexible membrane away from the dental arch by deflating the flexible membrane in response to a decrease in volume of the one or more enclosed compartments.

2. The portable oral care appliance according to claim 1, wherein the oral care action comprises one or more oral care cleaning cycles controlled by the control unit.

3. The portable oral care appliance according to claim 2, wherein each of the oral care cleaning cycles comprises at least one contraction phase and at least one relaxation phase of the mouthpiece.

4. The portable oral care appliance according to claim 1, further comprising a plurality of cleaning elements attached to the at least one flexible membrane.

5. The portable oral care appliance according to claim 4, wherein the control unit is configured to deform the at least one flexible membrane of the mouthpiece to transfer movement the plurality of cleaning elements in a controlled manner to thereby perform the oral care action.

6. The portable oral care appliance according to claim 4, wherein the plurality of cleaning elements are bristles and are made up of an elastomeric material.

7. The portable oral care appliance according to claim 4, wherein the plurality of cleaning elements are bristles and are made up of polyamide.

8. The portable oral care appliance according to claim 3, wherein the control unit is configured to regulate pressure inside the one or more enclosed compartments to create the contraction phase and the relaxation phase of the mouthpiece.

9. The portable oral care appliance according to claim 1, wherein the control unit comprises one or more of a pump, a motor, a valve mechanism, and a depression chamber.

10. The portable oral care appliance according to claim 1, wherein the control unit comprises a sensing means to monitor at least one operational characteristic.

11. The portable oral care appliance according to claim 10, wherein the sensing means monitors plurality of operational characteristics selected from the group consisting of pressure, volume, flow rate, time, and user input.

12. The portable oral care appliance according to claim 1, wherein the control unit comprises a power supply and a battery.

13. The portable oral care appliance according to claim 1, further comprising a cleaning agent injection unit configured to inject a cleaning agent for performing the oral care action.

14. The portable oral care appliance according to claim 1, wherein at least a portion of the outer surface of the mouthpiece is made up of a rigid material.

15. The portable oral care appliance according to claim 1, wherein at least a portion of the outer surface of the mouthpiece is made up of a flexible material.

16. The portable oral care appliance according to claim 1, wherein the mouthpiece comprises at least one of an inlet hole and an outlet hole.

17. The portable oral care appliance according to claim 1, wherein the mouthpiece comprises:
a U-shaped upper portion;
a U-shaped lower portion connected to the U-shaped upper portion; and
wherein oral care appliance is configured to perform the oral care action with the U-shaped upper portion and the U-shaped lower portion simultaneously or separately.

18. A method for utilizing a portable oral care appliance, the method comprising:
measuring pressure variations in one or more enclosed compartments of a mouthpiece using a pressure sensor;
varying pressure in the one or more enclosed compartments of the mouthpiece by a control unit between a compression phase and a relaxation phase of the portable oral care appliance, based on the measurements from the pressure sensor, wherein the one or more enclosed compartments are formed between an inner surface and an outer surface of the mouthpiece;
deforming at least one flexible membrane of the inner surface in response to the pressure variations caused in the one or more enclosed compartments, wherein the at least one flexible membrane is arranged to surround the one or more enclosed compartments;
wherein the deforming includes: (i) contracting the flexible membrane directly onto the dental arch in response to an increase in volume of the one or more enclosed compartments during the contraction phase of the oral care appliance; and (ii) relaxing the flexible membrane away from the dental arch in response to a decrease in volume of the one or more enclosed compartments during the relaxation phase of the oral care appliance; and
performing an oral care action by operating a plurality of cleaning elements attached to the at least one flexible membrane in response to the deformation caused in the at least one flexible membrane by the pressure variations.

19. The method according to claim 18, wherein the oral care action comprises one or more oral care cleaning cycles.

20. The method according to claim 19, wherein each of the oral care cleaning cycles comprises at least one contraction phase and at least one relaxation phase of the mouthpiece.

21. The method according to claim 18, wherein at least one flexible membrane of the mouthpiece is deformed by the control unit to transfer movement to the plurality of cleaning elements in a controlled manner to perform the oral care action.

22. The method according to claim 18, wherein the plurality of cleaning elements are bristles and are made up of an elastomeric material.

23. The method according to claim 18, wherein the plurality of cleaning elements are bristles and are made up of polyamide.

24. The method according to claim 18, wherein the step of performing an oral care action comprises injecting a cleaning agent.

25. The method according to claim 18, wherein at least a portion of the outer surface of the mouthpiece is made up of a rigid material.

26. The method according to claim 18, wherein the control unit comprises one or more of a pump, a motor, a valve mechanism, and a depression chamber.

27. The method according to claim 18, wherein the control unit further comprises a sensing means to monitor at least one operational characteristic.

28. The method according to claim 27, wherein the operational characteristic is selected from a plurality of operational characteristics comprising pressure, volume, flow rate, time, and user input.

29. The method according to claim 18, wherein the oral care action is removing plaque from the user's teeth or whitening of the user's teeth.

30. The portable oral care appliance according to claim 1, wherein:
the one or more enclosed compartments is a plurality of enclosed compartments.

31. The method according to claim 18, wherein:
the one or more enclosed compartments is a plurality of enclosed compartments.
